(19) United States
(12) Patent Application Publication
(10) Pub. No.: US 2006/0199539 A1
(43) Pub. Date: Sep. 7, 2006

(54) WIRELESS AUDIO TRANSMITTER

(75) Inventors: Eric Oh Yang, Hsuan (TW); Bor Kuan Lu, Hsuan (TW); Chi Jung Tsai, Hsuan (TW)

Correspondence Address: CONNOLLY BOVE LODGE & HUTZ LLP, SUITE 800, 1990 M STREET NW, WASHINGTON, DC, 20036-3425, US

(73) Assignee: ABOCOM SYSTEMS, INC., Hsinchu (TW)

(21) Appl. No.: 11/162,882

(22) Filed: Sep. 27, 2005

(30) Foreign Application Priority Data
Mar. 2, 2005 (TW) 094203188

(51) Int. Cl. H04B 7/00; H04M 1/00

(52) U.S. Cl. 455/41.2; 455/575.2

(57) ABSTRACT

A wireless audio transmitter is capable of converting audio signals into wireless Bluetooth signals. The transmitter comprises an ADC converting input analog audio signals into digital signals. A CPU outputs original data complying with Bluetooth communication protocols. The original data are sequentially processed by a Bluetooth base band processor and a Bluetooth RF processor, and are converted into RF signals. Finally, the RF signals are transmitted in a wireless microwave manner by an antenna.

### BACKGROUND OF THE INVENTION

1. Field of the Invention

The present invention relates to a wireless multimedia audio transmitter, and more particularly, to a transmitter converting audio signals into signals complying with Bluetooth communication protocols.

2. Description of the Related Art

Currently, a Bluetooth transmitter utilizing a USB interface is more popular than conventional Bluetooth transmitters, and is capable of transmitting digital musical signals generated by a personal computer (PC) or a laptop computer to Bluetooth headphones in a wireless manner. Therefore, a user wearing the headphones can enjoy melodies far from the aforesaid musical generator. However, such headphones are merely suitable for a multimedia player or a computer with a USB interface, and cannot communicate with common sound appliances used at home such as a television, a multimedia disc player and a speech amplifier. Consequently, the headphones are limited to a certain specific usage.

In addition, a wireless audio transmitter applicable to a television or a music player utilizes FM (frequency modulation) microwaves or infrared rays as a medium to wirelessly transmit converted audio signals. Because noises are likely to interfere with the FM microwaves and the infrared rays cannot penetrate through any blocks such as walls, this conventional wireless audio transmitter has a limited application scope and poor sound quality. Furthermore, it is necessary to adjust the specific working frequency or the specific wavelength of the transmitter for a matched receiver or headphones to receive such wireless signals, so that the transmitter cannot be arbitrarily used in different systems.

In summary, there is a significant demand for the communication market to have a multimedia audio transmitter that eliminates interference and is compatible with most communication systems. Therefore, the user can remotely receive wireless audio signals with high quality.

### SUMMARY OF THE INVENTION

An objective of the present invention is to provide a wireless multimedia audio transmitter which converts audio signals into Bluetooth signals. The transmitter is broadly applicable to appliances with an audio output terminal.

A second objective of the present invention is to provide a transmitter complying with Bluetooth communication protocols capable of transmitting signals to any receiver compatible with the same protocols. The correct communication between them is independent of the variation existing in the hardware of the receivers.

To achieve the objectives, the present invention discloses a wireless audio transmitter capable of converting audio signals into wireless Bluetooth signals. The transmitter comprises an analog-to-digital converter (ADC) transforming input analog audio signals into digital signals. A central processing unit (CPU) outputs original data complying with the Bluetooth communication protocols. The original data are sequentially processed by a Bluetooth base band processor and a Bluetooth radio frequency (RF) processor, and are converted into RF signals. Finally, the RF signals are transmitted in a wireless microwave manner by an antenna.

### BRIEF DESCRIPTION OF THE DRAWINGS

The invention will be described according to the appended drawings in which:

FIG. 1 is a schematic diagram of a transmitter application in accordance with the present invention;

FIG. 2 is a function block diagram of a wireless audio transmitter in accordance with the present invention; and

FIG. 3 is a schematic diagram of another transmitter application in accordance with the present invention.

### PREFERRED EMBODIMENT OF THE PRESENT INVENTION

Referring to a Bluetooth operation model, a miniature RF and base-band chip set placed in a Bluetooth wireless apparatus employs an ISM (Industrial Scientific, Medical) band with a central frequency of 2.4 GHz, which is free to use. The corresponding frequency band is divided into 79 different channels, and the frequency band of each channel is 1 MHz. To avoid interference between wireless apparatuses all employing the ISM band, a Frequency-Hopping Spread Spectrum (FHSS) technique is utilized to perform the difficult frequency swap rate of 1,600 times a second. In addition, an encryption technique is utilized so that the data exchange security is very high. Accordingly, the effective baud rate of the Bluetooth wireless apparatus is from 432-721 Kbps, and the effective transmitting distance is from 10 to 100 meters.

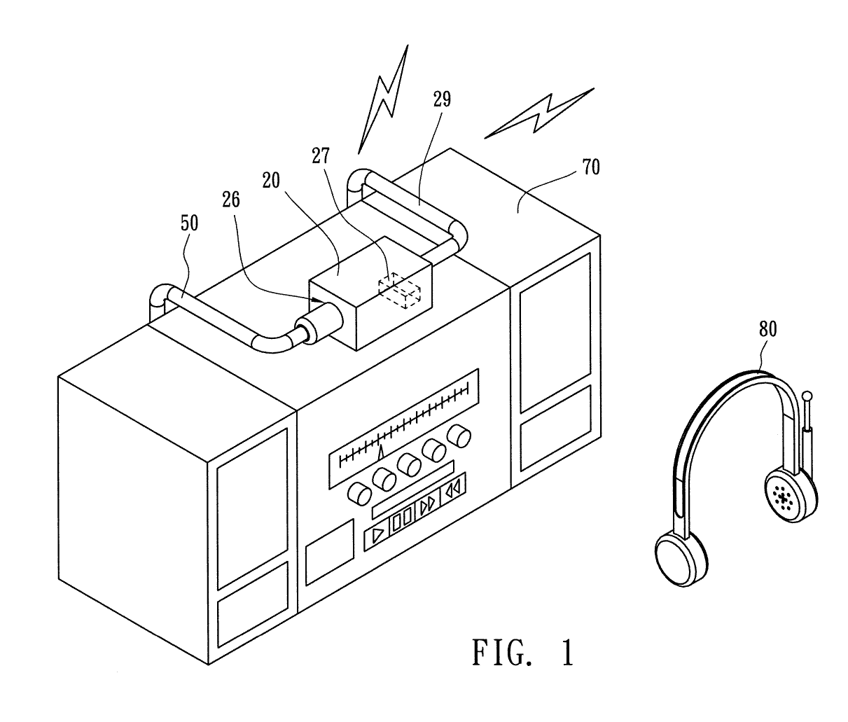

FIG. 1 is a schematic diagram of a transmitter application in accordance with the present invention. The audio signals from the hi-fi equipment 70 are inputted to the wireless audio transmitter 20 through a connection cable 50. An audio input socket 26, in which the plug of the connection cable 50 is plugged, is provided on the wireless audio transmitter 20. The wireless audio transmitter 20 is capable of transforming the audio signals to corresponding wireless Bluetooth signals. A receiver 80 complying with Bluetooth communication protocols receives the wireless Bluetooth signals and transforms the received signals to sound directly heard by a user. Furthermore, the wireless audio transmitter 20 is directly powered by a battery set 27 or a power supply cord 29 which also can be utilized to charge the battery set 27.

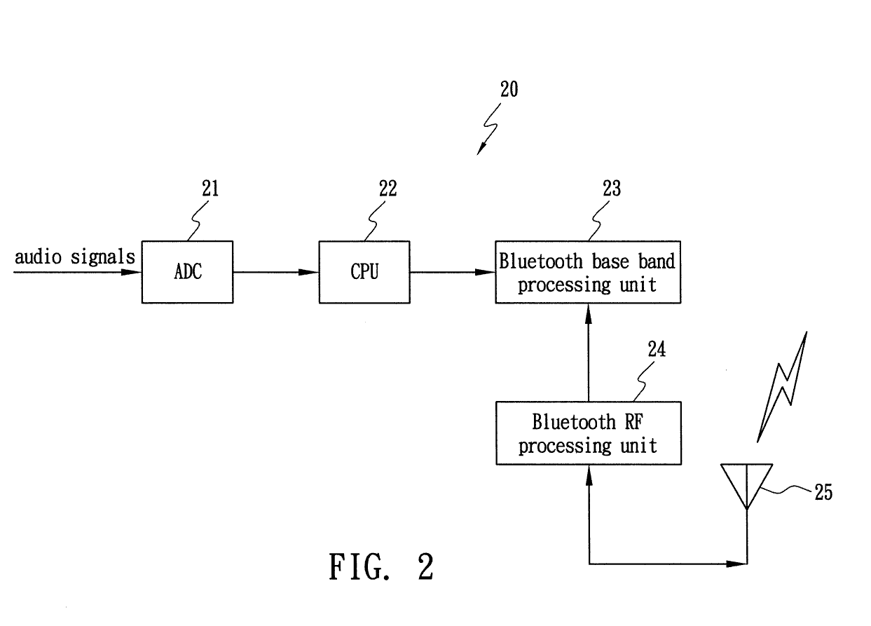

FIG. 2 is a function block diagram of a wireless audio transmitter in accordance with the present invention. The wireless audio transmitter 20 comprises an analog-to-digital converter (ADC) 21 which transforms the analog audio signals from the hi-fi equipment 70 to the corresponding digital signals, wherein the audio signals are stereo audio including right and left ear channels. The ADC 21 utilizes a pulse code modulation (PCM) method to sample and quantitate the analog audio signals. In conclusion, the amplitude of each quantitative pulse is represented by a set of binary codes.

The digital signals are transformed to source data complying with the Bluetooth communication protocols through a central processing unit (CPU) 22. Afterward, the source data are processed in a base band transformation by a Bluetooth base band processing unit 23. The processed Bluetooth base band signals are further converted to radio frequency (RF) signals by a Bluetooth RF processing unit 24. Finally, an antenna 25 broadcasts the audio signals in a wireless microwave manner. In addition, the CPU 22 can output the digital signals to a Universal Asynchronous Receiver Transmitter (UART) which transmits and receives series data at the same time. Furthermore, the CPU 22, Bluetooth base band processing unit 23 and Bluetooth RF processing unit 24 are integrated into just a single chip, hence the occupied space is reduced.

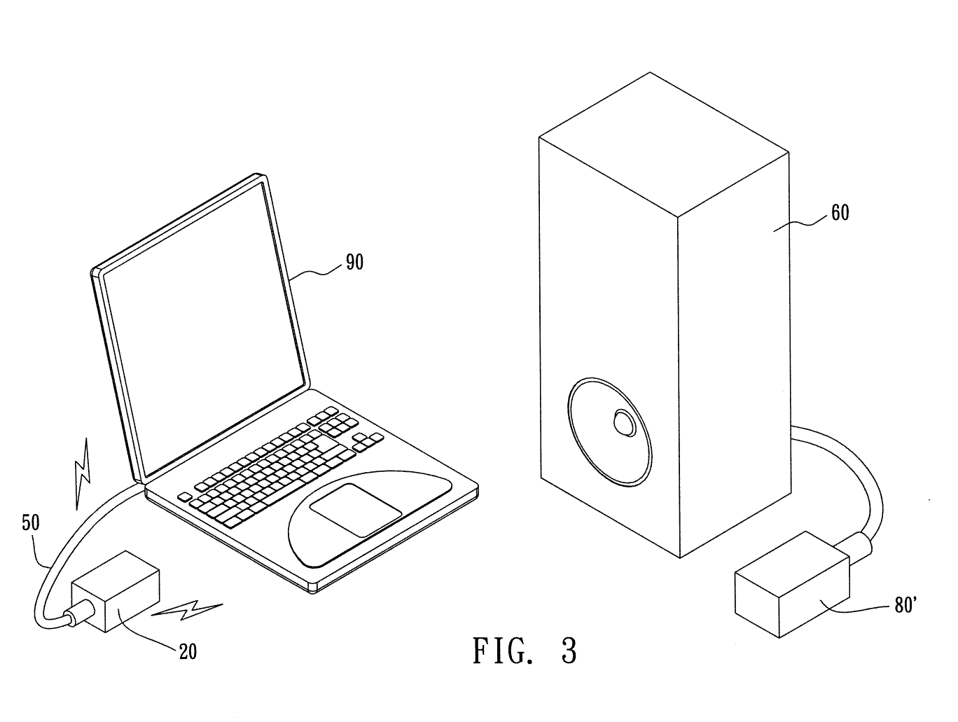

FIG. 3 is a schematic diagram of another transmitter application in accordance with the present invention. The audio signals from a personal computer 90 are inputted to the wireless audio transmitter 20 through a connection cable 50. The wireless audio transmitter 20 transforms the audio signals to corresponding wireless Bluetooth signals received by a receiver 80 complying with Bluetooth communication protocols. Finally, an amplifier 60 emits sound after converting the wireless Bluetooth signals to audio signals.

The above-described embodiments of the present invention are intended to be illustrative only. Numerous alternative embodiments may be devised by persons skilled in the art without departing from the scope of the following claims.

What is claimed as new and desired to be protected by Letters Patent of the United States is:

1. A wireless audio transmitter capable of converting audio signals into wireless Bluetooth signals, comprising:
an analog-to-digital converter (ADC) converting analog audio signals into digital signals;
a central processing unit (CPU) transforming the digital signals into original data complying with Bluetooth communication protocols;
a Bluetooth base band processor transforming the original data into base band signals;
a Bluetooth radio frequency (RF) processor transforming the base band signals into RF signals; and
an antenna emitting the RF signals in a wireless microwave manner.

2. The wireless audio transmitter of claim 1, further comprising an audio input socket for receiving the audio signals.

3. The wireless audio transmitter of claim 1, wherein the ADC utilizes a pulse code modulation (PCM) method to digitalize the audio signals.

4. The wireless audio transmitter of claim 1, further comprising a battery set supplying electrical power to the wireless audio transmitter.

5. The wireless audio transmitter of claim 1, further comprising a power supply cord externally supplying electrical power to the wireless audio transmitter.

6. The wireless audio transmitter of claim 1, wherein the CPU, the Bluetooth base band processor and the Bluetooth RF processor are integrated into a single chip.

7. The wireless audio transmitter of claim 1, wherein the audio signals are stereo audio including right and left ear channels.
